(19) United States
(12) Patent Application Publication
(10) Pub. No.: US 2023/0242339 A1
(43) Pub. Date: Aug. 3, 2023

(54) TRANSPORT OF STRUCTURAL ELEMENTS FOR PACKAGINGS

(71) Applicant: MULTIVAC SEPP HAGGENMUELLER SE & CO. KG, Wolfertschwenden (DE)

(72) Inventors: Robert MAIER, Babenhausen (DE); Dominik PATZ, Kempten (DE); Philipp ADERMANN, Kempten (DE); Bernd HOEPNER, Kempten (DE)

(73) Assignee: MULTIVAC SEPP HAGGENMUELLER SE & CO. KG, Wolfertschwenden (DE)

(21) Appl. No.: 18/104,094

(22) Filed: Jan. 31, 2023

(30) Foreign Application Priority Data
Feb. 1, 2022 (DE) 102022102311.7

(51) Int. Cl. B65G 1/04; B65G 1/12

(52) U.S. Cl. CPC B65G 1/0464; B65G 1/12

(57) ABSTRACT

A method for transporting structural elements of packagings includes transferring a group of structural elements to a holding device, wherein each structural element of the group of structural elements is received by an associated holding element of the holding device after the transfer, and adjusting the holding elements relative to each other such that the structural elements of the group of structural elements received by the holding elements are disposed before the adjusting in a first format in which the structural elements of the group of structural elements are arranged in a plan view in a first spacing grid relative to each other, and are disposed after the adjusting in a second format in which the structural elements of the group of structural elements are arranged in the plan view in a second spacing grid relative to each other, the second spacing grid being different from the first spacing grid.

### CROSS REFERENCE TO RELATED APPLICATIONS

This application claims foreign priority benefits under 35 U.S.C. § 119(a)-(d) to German patent application number DE 10 2022 102 311.7, filed Feb. 1, 2022, which is incorporated by reference in its entirety.

### TECHNICAL FIELD

The disclosure relates to the transport of structural elements for packagings.

### BACKGROUND

DE 10 2018 214 760 A1 describes a deep-drawing packaging machine with a transport device which includes a transfer unit with which trays fed from outside the packaging machine can be received within a machine frame of the packaging machine, moved on and transferred to a forming station located upstream next to the transfer unit. The transfer unit is configured as a suction plate, which is mounted so that it can be moved by means of a linear drive in or against a working direction of the packaging machine between a receiving position and a transfer position. The suction plate comprises several receiving molds which can at least partially receive trays made available to them for transport as a negative molds in a positive locking manner. The trays are transferred in a predetermined format to a vertically adjustable lifting mechanism of the transport device arranged within the machine frame of the packaging machine. The lifting mechanism is configured to lift the trays disposed on it in order to transfer the trays to the transfer unit disposed above it in a receiving position.

### SUMMARY

It is an object of the disclosure to provide an improved way of transporting structural elements for packagings.

According to an embodiment of the disclosure, a transport arrangement for structural elements for packagings is provided. The transport arrangement comprises a holding device and a lifting arrangement. The holding device comprises a group of holding elements. The holding elements are each configured to hold a structural element to be transported. The lifting arrangement is configured to produce a relative movement towards each other along a vertical direction between a group of structural elements and the holding device. The group of structural elements is in a transfer position at least at the beginning of the relative movement The group of structural elements is received by the group of holding elements at the end of the relative movement. The holding elements of the holding device are adjustable relative to each other between a receiving configuration and a dispensing configuration. In the receiving configuration, the holding elements are arranged relative to each other such that a group of structural elements received by the holding elements is disposed in a first format. In the first format, the structural elements are arranged in plan view in a first spacing grid relative to each other. In the dispensing configuration, the holding elements are arranged relative to each other such that a group of structural elements received by the holding elements is disposed in a second format. In the second format, the structural elements are arranged in plan view in a second spacing grid relative to each other. The second spacing grid is different from the first spacing grid.

Since the relative movement between the group of structural elements and the holding device for transferring the structural elements to the holding device is carried out along a vertical direction, the transport arrangement can be implemented in a comparatively space efficient manner. The adjustability of the holding elements relative to each other allows the format in which the group of structural elements is disposed to be changed while the structural elements are received by the holding device. The structural elements can be transferred to the holding device in the first format and then transferred to a second format by adjusting the holding elements from the receiving configuration to the dispensing configuration. The holding device may dispense the group of structural elements in a different format than received. For example, the holding device may receive the structural elements in the first format and dispense them in the second format. By suitably selecting the first format and the second format, the transport arrangement can be efficiently integrated into a higher-level system, such as a packaging line. If the structural elements are disposed in a certain format before being transferred to the holding device and are to be further processed in a different format after being dispensed by the holding device, the format adjustment can be carried out by the holding device itself. An additional device upstream or downstream of the transport arrangement for changing an arrangement of the structural elements relative to each other can thus be omitted.

In the transfer position, the group of structural elements may be disposed in the first format. The group of structural elements may be transferred to the holding device in the first format. The group of structural elements may be disposed in the first format during the relative vertical movement between the group of structural elements and the holding device. The first format may be any format in which the structural elements are disposed before transfer to the holding device. For example, the first format may be a format in which the structural elements are processed by a workstation upstream of the transport arrangement, or a format in which the structural elements are provided to the transport arrangement, for example by a destacking device.

The transport arrangement may further comprise a provisioning device configured to bring the group of structural elements into the transfer position. The provisioning device may comprise a conveyor belt for the structural elements. The provisioning device may be configured to bring the group of structural elements in the first format into the transfer position. The provisioning device may be configured to bring structural elements provided by a destacking device into the transfer position.

The holding device may comprise an adjustment arrangement. The adjustment arrangement may be configured to automatically adjust the holding elements relative to each other between the receiving configuration and the dispensing configuration. The adjustment arrangement may comprise at least one adjustment drive which drives the adjustment of the holding elements relative to each other between the receiving configuration and the dispensing configuration. The at least one adjustment drive can be configured as a servo drive.

The transport arrangement may be configurable such that the first format is adaptable in a variable way. The transport arrangement may be configurable such that the second format is adaptable in a variable way. The transport arrangement may comprise an operator interface by which the first format and/or the second format can be adjusted in a variable way. An adjustment of the first format or the second format may include adjusting the spacing grid in which the structural elements disposed in the respective format are arranged relative to each other. Due to an adaptability of the first format and the second format, the transport arrangement can be used flexibly in different application scenarios. Adaptability of the first format and/or the second format facilitates adaptation of the transport arrangement to upstream or downstream processing steps and to properties of the structural elements to be processed.

The holding elements may be displaceable relative to each other in a horizontal plane for adjustment between the receiving configuration and the dispensing configuration. Displacement vectors of the holding elements when moving between the receiving configuration and the dispensing configuration may include at least one portion that is disposed in a horizontal plane. Displacement vectors of the holding elements when moving between the receiving configuration and the dispensing configuration may include a vertical component. Displacement vectors of the holding elements when moving between the receiving configuration and the dispensing configuration may be disposed exclusively in a horizontal plane, i.e., have no vertical component.

Moving the holding elements relative to each other between the receiving configuration and the dispensing configuration may involve purely translational movements of the holding elements relative to each other. Moving the holding elements relative to each other between the receiving configuration and the dispensing configuration may involve purely rotational movements of the holding elements relative to each other. Moving the holding elements relative to each other between the receiving configuration and the dispensing configuration may comprise both a translational movement of the holding elements relative to each other and a rotational movement of the holding elements relative to each other.

When moving between the receiving configuration and the dispensing configuration, all holding elements of the holding device may be moved relative to each other or only some of the holding elements of the holding device may be moved relative to each other.

The transport arrangement may comprise a transport drive arrangement. The transport drive arrangement may be configured to move the holding device as a whole to transport a group of structural elements received by the holding elements. The movement of the holding device as a whole may comprise a component in a horizontal plane or may be a movement exclusively in a horizontal plane. The movement of the holding device as a whole may comprise a translational movement. The movement of the holding device as a whole may comprise a rotational movement. The movement of the holding device as a whole may comprise a translational movement and a rotational movement. The movement of the holding device as a whole may be or comprise a movement along or against a production direction of a packaging machine supplied by the transport arrangement with the structural elements.

The transport arrangement may be configured to move the holding elements relative to each other between the receiving configuration and the dispensing configuration while the holding device is moved as a whole. This allows a format change to be carried out in a timesaving manner during transport of the structural elements through the holding device.

The lifting arrangement may be configured to deform the structural elements. In particular, the lifting arrangement may be configured to deform the structural elements during the relative movement between the group of structural elements and the holding device. Deforming the structural elements may comprise folding or bending the structural elements. An area occupied by the structural elements in plan view of the structural elements may change, in particular decrease, due to the deforming of the structural elements. Deforming the structural elements may comprise deforming from a flat blank of material into a packaging tray.

During the relative movement between the group of structural elements and the holding device by the lifting arrangement, a format in which the structural elements are arranged may remain the same. During the relative movement between the group of structural elements and the holding device by the lifting arrangement, a spacing grid in which the structural elements are arranged in plan view relative to each other may remain the same. The spacing grid may be defined by a mutual arrangement of geometric centers of the structural elements in plan view of the structural elements or by a mutual arrangement of centers of mass of the structural elements in projection in a horizontal plane.

The lifting arrangement may be configured to retain the structural elements at least in portions on an element of the lifting arrangement during the relative movement between the group of structural elements and the holding device.

The lifting arrangement may comprise suction devices configured to hold the structural elements during the relative movement between the group of structural elements and the holding device by suction. The suction devices may be configured to deform the structural elements when holding the structural elements by suction.

The lifting arrangement may be configured to lift the group of structural elements from the transfer position along the vertical direction. Alternatively, or additionally, the lifting arrangement may be configured to lower the holding device along the vertical direction.

The structural elements may be provided below the holding device in the transfer position.

The holding elements may be configured to receive and hold structural elements approaching the holding elements from below in a relative movement. The holding elements may comprise suction devices for holding the structural elements by suction. The suction devices of the holding elements may be supplied with vacuum from a vacuum arrangement of the transport arrangement for holding the structural elements by suction.

The holding elements may have a shape at least substantially complementary to the structural elements. At the end of the relative movement, the structural elements may be mounted on the holding elements.

The holding elements may each comprise a groove which is configured to receive an engagement portion of the structural elements. If the structural elements are transferred to the holding elements as packaging trays, the receiving section may be an peripheral area of the packaging tray surrounding the opening of the packaging tray. Receiving the receiving area of the structural elements in the groove of the holding elements may counteract a deformation, in particular a re-deformation, of the structural elements.

The structural elements may comprise a material containing fibers, in particular a material containing natural fibers. The structural elements may comprise a paper material or a cardboard material. The structural elements may comprise a plastic material. The structural elements can each comprise a cut-out from a sheet of material. The structural elements may comprise a laminate of multiple layers of material. The structural elements may comprise a laminate of a cardboard layer and a plastic layer. The structural elements may comprise a laminate of a paper layer and a plastic layer.

According to another embodiment of the disclosure, there is provided a packaging machine with the transport arrangement described above. The packaging machine may be configured as a deep-drawing packaging machine. The packaging machine may comprise a forming station.

The forming station may be configured to form packaging trays in a bottom film web conveyed along a production direction of the packaging machine by deep-drawing. The transport arrangement may be configured to feed the structural elements to the forming station. The transport arrangement may be configured to feed the structural elements to the forming station in the form of packaging trays. The forming station may be configured to deform the bottom film web into the structural elements so that the structural elements are laminated to the bottom film web. The forming station may be configured to bond the structural elements to the bottom film web, in particular by heat and/or pressure.

The packaging machine may comprise a sealing station, which is arranged downstream of the forming station, in particular with regard to the production direction of the packaging machine. The sealing station may be configured to seal the packaging trays by sealing a top film.

The holding device of the transport arrangement may be configured to be moved as a whole along or against the production direction of the packaging machine. The holding device may be movable below a transport plane of the bottom film web within the packaging machine.

According to another embodiment of the disclosure, a method for transporting structural elements of packagings is provided. A group of structural elements is transferred to a holding device. After being transferred to the holding device, the structural elements are each held by a holding element of the holding device. The holding elements are adjusted relative to each other so that the structural elements received by the holding elements are disposed in a first format before the adjusting and are disposed in a second format after the adjusting. In the first format, the structural elements are arranged in plan view in a first spacing grid relative to each other. In the second format, the structural elements are arranged in plan view in a second spacing grid relative to each other. The second spacing grid is different from the first spacing grid.

The holding device may be moved as a whole to transport the structural elements received by the holding elements.

The structural elements may be disposed in the first format when transferred to the holding device. The structural elements may be dispensed from the holding device in the second format.

The structural elements may be received from the holding elements in a suspended configuration.

To transfer the structural elements to the holding device, a relative movement between the structural elements and the holding device may be carried out. The relative movement between the structural elements and the holding device may be carried out along a vertical direction. During the relative movement between the structural elements and the holding device, the structural elements may be deformed, in particular by a lifting arrangement. When the structural elements are deformed, a gap between adjacent structural elements may change in plan view of the structural elements. In particular, the gap may increase during the forming process.

According to another embodiment of the disclosure, a use of a holding device with a group of holding elements movable relative to each other for transporting a group of structural elements for packagings by a translational movement of the holding device as a whole and for changing a mutual position of the structural elements relative to each other by shifting the holding elements relative to each other is provided.

According to the described embodiments of the disclosure, a transport arrangement, a packaging machine, a method for transporting structural elements of packagings and a use of a holding device are provided. Features, explanations and advantages described in relation to one of these embodiments can be transferred to the other embodiments. The method and use may be carried out on the transport arrangement or the packaging machine. The transport arrangement and the packaging machine may be suitable, designed and/or configured to perform the method or the use.

### BRIEF DESCRIPTION OF THE DRAWINGS

In the following, the disclosure is further described with reference to the figures by means of embodiments.

FIG. 1 is a schematic side view of a packaging machine according to an embodiment;

FIG. 2 is a schematic plan view of a packaging machine according to an embodiment;

FIG. 3 is a schematic illustration of a transport arrangement for structural elements according to an embodiment;

FIG. 4 is a schematic illustration of different steps during the transfer of a group of structural elements to the holding device according to an embodiment; and

FIG. 5 is a schematic illustration of a transfer of a group of structural elements between a first format and a second format by adjusting the holding elements of the holding device of a transport arrangement according to an embodiment.

### DETAILED DESCRIPTION

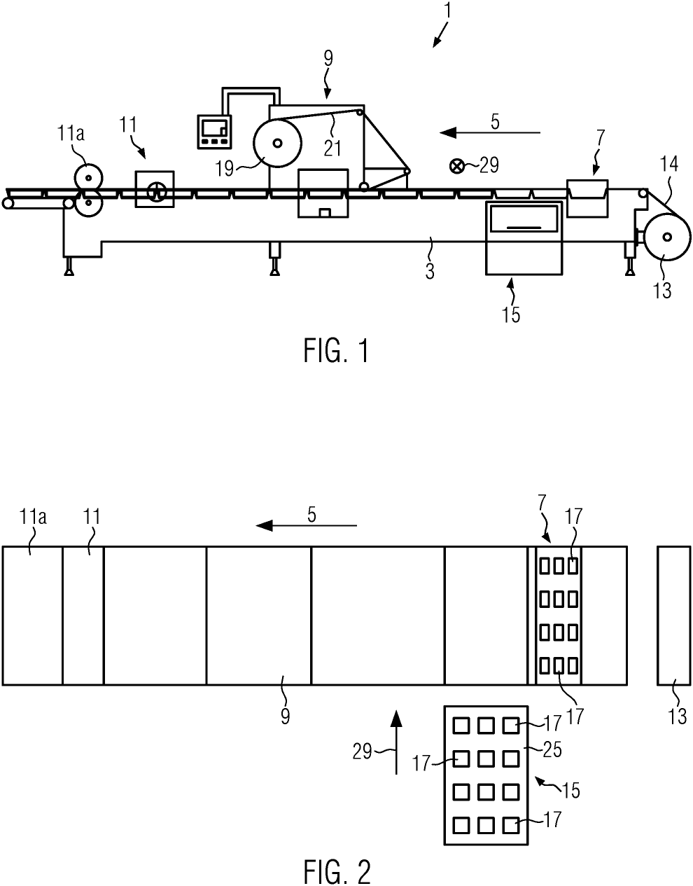

FIG. 1 shows a schematic side view of a packaging machine 1 configured as a deep-drawing packaging machine according to an embodiment. The packaging machine 1 comprises a machine frame 3 on which a forming station 7, a sealing station 9, a transverse cutting station 11 and a longitudinal cutting station 11a are arranged in succession along a production direction 5. A feed device conveys a bottom film web 14 drawn from a supply roll 13 along the production direction 5 successively through the forming station 7 and the sealing station 9 and to the cutting stations 11a.

A transport arrangement 15 supplies the forming station 7 with structural elements 17 in the form of packaging trays. In particular, the structural elements 17 can be transferred to a bottom tool of the forming station 7 by the transport arrangement 15. By interaction of the bottom tool and a top tool of the forming station 7, the bottom film web 14 is formed from above into the structural elements 17, which are configured as packaging trays, and connected to the structural elements 17. An inner space of the packaging trays is lined with the bottom film web 14 in the forming station 7, so to speak.

In relation to the production direction 5, products to be packaged are placed in the packaging trays between the forming station 7 and the sealing station 9. In the sealing station 9, the packaging trays are sealed by sealing an top film web 21 pulled from a supply roll 19 to the bottom film web 14. This can be done by sealing interaction of a bottom tool part and a top tool part of the sealing station 9, in particular under the effect of heat and/or pressure. The individual packaging trays are separated from the film composite in the cutting stations 11, 11a.

To increase the production output of the packaging machine 1, several packaging trays are processed simultaneously in the forming station 7 and the sealing station 9. In the embodiment shown, twelve packaging trays are processed simultaneously, which are disposed in a 4×3 format.

In the following, the feeding of the structural elements 17 by the transport arrangement 15 is described in more detail.

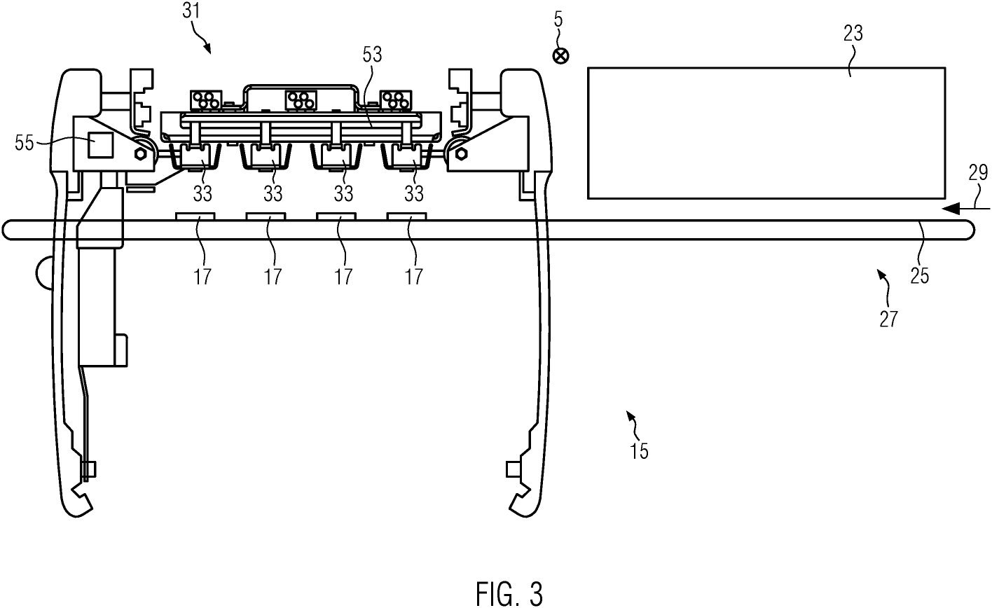

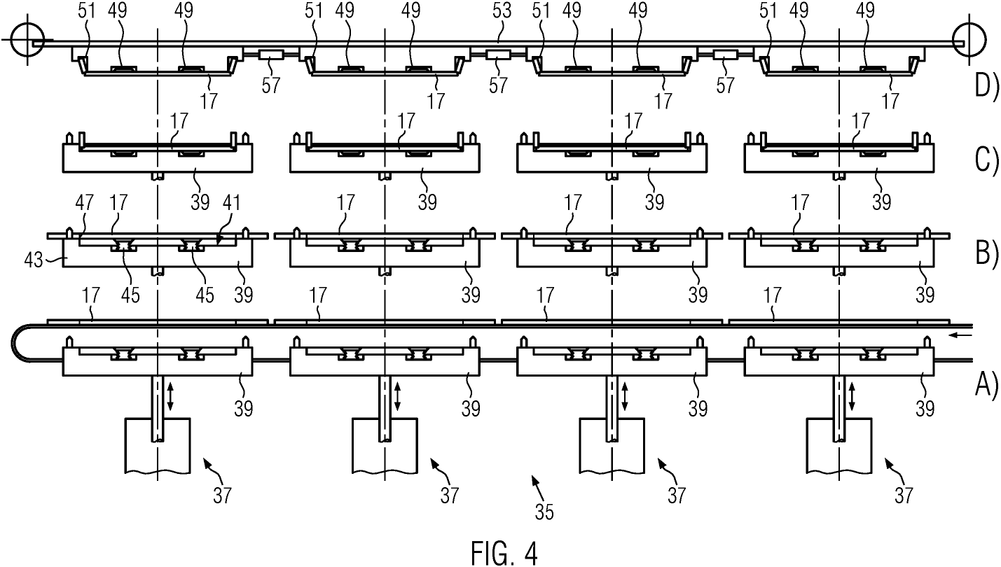

FIG. 3 shows a sectional view through the packaging machine 1 in the area of the transport arrangement 15, wherein the sectional plane is perpendicular to the production direction 5. In the embodiment shown, the structural elements 17 are destacked by a destacking device 23 onto a conveyor system 25 of a provisioning device 27. The destacking device 23 is provided laterally offset with respect to the production direction 5.

In FIG. 2, the destacking device 23 is not shown, so that the conveyor system 25 with structural elements 17 destacked on it is visible in the plan view of the packaging machine 1 shown in FIG. 2. In the embodiment shown, the structural elements 17 are destacked such that they are disposed in a first format on the conveyor system 25, which in the illustrated embodiment is a 4×3 format.

The structural elements 17 are destacked as flat material blanks made of cardboard or paper. By means of the conveyor system 25 of the provisioning device 27, the destacked structural elements 17 in the first format are conveyed along a feed direction 29, which is perpendicular to the production direction 5 of the packaging machine 1, into an area within the machine frame 3 of the packaging machine 1.

FIG. 3 shows a group of structural elements 17 in the first format in a transfer position within an area defined by the machine frame 3. In the transfer position, the structural elements 17 are disposed directly under a holding device 31 of the transport arrangement 15. The holding device 31 comprises a group of holding elements 33. The number of holding elements 33 corresponds to the number of structural elements 17 in a format. In the situation shown in FIG. 3, the holding elements 33 are arranged relative to each other in a horizontal plane corresponding to the arrangement of the structural elements 17 in the first format.

From the transfer position shown in FIG. 3, the structural elements 17 are lifted in a vertical direction by a lifting arrangement 35 not shown in FIG. 3 and transferred to the holding elements 33 of the holding device 31. This is shown schematically in FIG. 4, also in a sectional view with a sectional plane perpendicular to the production direction 5. As shown in FIG. 4, the lifting arrangement 35 comprises lifting elements 37 assigned to the individual structural elements 17 of the format, each of which is provided with a lifting drive. Alternatively, the lifting elements 37 could be interconnected so that only one common lifting drive is required. FIG. 4 shows in parts A), B), C) and D) a time sequence of the lifting of the structural elements 17 by the lifting arrangement 35. The lifting elements 37 each comprise a lifting bed 39, which approaches the corresponding structural element 17 from below and carries it upwards. In the raised state in part B) of FIG. 3, the lifting elements 37 have already lifted the structural elements 17 above the conveyor system 25. The lifting beds 39 each have a forming area 41 which is open at the top and is surrounded by a border area 43. In the forming area 41, suction openings 45 are provided in the lifting beds 39. By applying a vacuum in the forming area 41 through the suction openings 45, the structural elements 17 are sucked into the forming area 41 during further upward movement. The structural elements 17 thereby fold at predetermined folding points 47 corresponding to a boundary area between the forming area 41 and the border area 43 and are thus deformed into packaging trays.

In part C) in FIG. 4, the structural elements 17 have already been deformed. The structural elements 17 are moved further upwards to finally be transferred to the holding elements 33 as shown in part D). The holding elements 33 comprise suction openings 49 for sucking the structural elements 17 to the holding elements 33 by applying a vacuum through the suction openings 49, thereby holding them in a suspended state on the holding elements 33.

In the embodiment shown, the holding elements 33 each comprise a circumferential groove 51, which is open downward and in which a peripheral area of the structural elements 17 folded upward engages. This prevents the peripheral areas of the structural elements 17 from folding back. After the transfer of the structural elements 17 to the holding device 31, the lifting elements 39 of the lifting arrangement 35 move down again to be ready to receive the next format of structural elements 17.

The holding elements 33 of the holding arrangement 31 are provided on a base body 53 of the holding arrangement 31. The base body 53 is movably mounted with respect to the production direction 5 of the packaging machine 1. The transport arrangement 15 comprises a transport drive arrangement 55, shown schematically in FIG. 3, which is configured to move the holding device 31 accordingly. After transfer of the structural elements 17 to the holding elements 33, the holding device 31 is moved as a whole against the production direction 5 into the forming station 7 by the transport drive arrangement 55. Before or during this moving of the holding device 31, the format of the group of structural elements 17 received by the holding elements 33 is changed from the first format to a second format. This is done by moving the receiving elements 33 relative to each other in a horizontal plane. Corresponding adjustment devices 57 are shown schematically in FIG. 4.

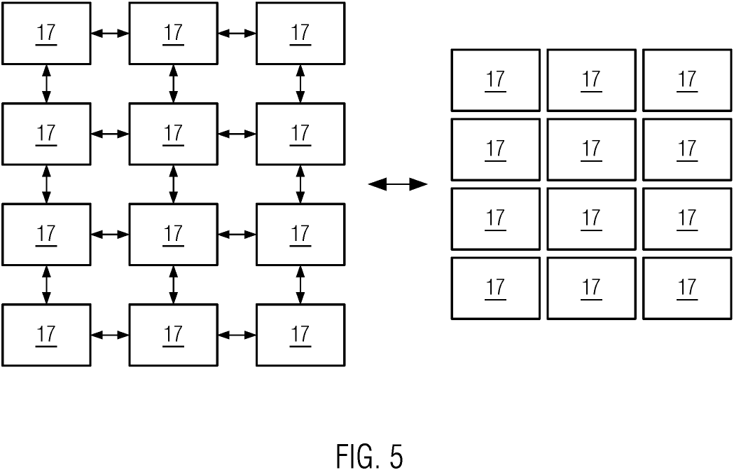

By changing the format in which the structural elements 17 are disposed, the arrangement of the structural elements 17 can be adapted to the requirements of the forming station 7. FIG. 5 shows in the left part in plan view the disposition of the structural elements 17 in the first format after transfer to the holding device 31. From the first format, the structural elements 17 are brought into a second format shown in the right part of FIG. 5, in which the structural elements 17 are closer together, by moving the receiving elements 33 relative to each other. Moving the structural elements 17 together after transfer to the holding device 31 may be particularly advantageous in order to reduce an increased distance between adjacent structural elements 17 after the structural elements 17 have been deformed into packaging trays, so that the structural elements 17 can be transferred to the forming station 7 in a sufficiently compact format. However, it would also be conceivable to move the structural elements 17 further apart during the transition from the first format to the second format or to otherwise change the mutual position of the structural elements 17.

The structural elements 17 are transferred from the holding device 31 to the forming station 7 in the second format. FIG. 2 shows schematically the structural elements 17 arranged in the second format in the forming station 7. After transferring the structural elements in the second format to the forming station 7, the transport drive arrangement 55 moves the holding device 31 along the production direction 5 to be ready to receive the next group of structural elements 17. In addition, the receiving elements 33 are moved again relative to each other in order to be able to receive the next group of structural elements 17 in the first format.

What is claimed is:

1. A transport arrangement for structural elements for packagings, comprising:
a holding device with a group of holding elements, each holding element of the group of holding elements being configured to receive a structural element to be transported for holding; and
a lifting arrangement configured to produce a relative movement in a vertical direction between a group of structural elements and the holding device, the group of structural elements being in a transfer position at a beginning of the relative movement and being received by the group of holding elements at an end of the relative movement;
wherein the holding elements of the group of holding elements of the holding device are adjustable relative to each other between a receiving configuration and a dispensing configuration;
wherein, in the receiving configuration, the holding elements of the group of holding elements are arranged relative to each other such that a group of structural elements received by the group of holding elements is disposed in a first format in which the structural elements of the group of structural elements are arranged in a plan view in a first spacing grid relative to each other; and
wherein, in the dispensing configuration, the holding elements of the group of holding elements are arranged relative to each other such that a group of structural elements received by the group of holding elements is disposed in a second format in which the structural elements of the group of structural elements are arranged in the plan view in a second spacing grid relative to each other, the second spacing grid being different from the first spacing grid.

2. The transport arrangement according to claim 1, wherein, in the transfer position, the group of structural elements is disposed in the first format.

3. The transport arrangement according to claim 1, further comprising a provisioning device configured to bring the group of structural elements into the transfer position.

4. The transport arrangement according to claim 1, wherein the holding device comprises an adjustment arrangement configured to automatically adjust the holding elements of the group of holding elements relative to each other between the receiving configuration and the dispensing configuration.

5. The transport arrangement according to claim 1, wherein the holding elements of the group of holding elements are displaceable relative to each other in a horizontal plane for adjustment between the receiving configuration and the dispensing configuration.

6. The transport arrangement according to claim 1, further comprising a transport drive arrangement configured to move the holding device for transporting a group of structural elements received by the holding elements as a whole.

7. The transport arrangement according to claim 1, wherein the lifting arrangement is configured to deform the structural elements of the group of structural elements during the relative movement between the group of structural elements and the holding device.

8. The transport arrangement according to claim 1, wherein the lifting arrangement is configured to lift the group of structural elements from the transfer position along the vertical direction.

9. A method for transporting structural elements of packagings, comprising:
transferring a group of structural elements to a holding device, wherein each structural element of the group of structural elements is received by an associated holding element of the holding device after the transfer; and
adjusting the holding elements relative to each other such that the structural elements of the group of structural elements received by the holding elements are disposed before the adjusting in a first format in which the structural elements of the group of structural elements are arranged in a plan view in a first spacing grid relative to each other, and are disposed after the adjusting in a second format in which the structural elements of the group of structural elements are arranged in the plan view in a second spacing grid relative to each other, the second spacing grid being different from the first spacing grid.

10. The method according to claim 9, wherein the holding device is moved as a whole to transport the structural elements of the group of structural elements received by the holding elements.

11. The method according to claim 9, wherein the structural elements of the group of structural elements are disposed in the first format when they are transferred to the holding device, and are dispensed from the holding device in the second format.

12. The method according to claim 9, wherein the structural elements of the group of structural elements are received by the holding elements in a suspended configuration.

13. The method according to claim 9, wherein, for transferring the structural elements of the group of structural elements to the holding device, a relative movement along a vertical direction is carried out between the structural elements of the group of structural elements and the holding device, and the structural elements of the group of structural elements are deformed during the relative movement.

14. The method according to claim 13, wherein a distance between adjacent structural elements in the plan view of the group of structural elements increases during the deforming.

15. A method for operating a holding device with holding elements movable relative to each other, the method comprising:
transporting a group of structural elements for packagings by a translational movement of the holding device as a whole; and
changing positions of structural elements of the group of structural elements relative to each other by shifting the holding elements relative to each other.
